(19) United States
(12) Patent Application Publication
(10) Pub. No.: US 2013/0250555 A1
(43) Pub. Date: Sep. 26, 2013

(54) ADAPTER FOR ATTACHING LIGHTING EQUIPMENT, LUMINAIRE IN WHICH THE ADAPTER IS COMBINED WITH THE LIGHTING EQUIPMENT, AND METHOD OF ATTACHING THE LIGHTING EQUIPMENT

(71) Applicant: Yasuhiro SANO, Yokosuka-shi (JP)

(72) Inventor: Yasuhiro SANO, Yokosuka-shi (JP)

(73) Assignee: Toshiba Lighting & Technology Corporation, Kanagawa (JP)

(21) Appl. No.: 13/532,260

(22) Filed: Jun. 25, 2012

(30) Foreign Application Priority Data
Mar. 23, 2012 (JP) 2012-068080

(51) Int. Cl. F21S 8/04; B23P 6/00

(52) U.S. Cl. 362/147; 29/402.08

(57) ABSTRACT

An adapter includes a tabular body configured to close the existing attachment hole opened in the ceiling in a state in which the existing lighting equipment is removed and a positioning convex section protrudingly provided on the front surface of the tabular body on a side remote from the ceiling. A part of a chassis of lighting equipment to be attached anew is partially projected toward the rear surface of a substrate mounted with a light-emitting element and forms a contact convex section. A fitting concave section is formed on the rear side of the contact convex section. The positioning convex section is fit in the fitting concave section formed on a rear side of the contact convex section, whereby the lighting equipment to be attached anew is positioned with respect to and combined with the adapter and attached to the ceiling together with the adapter.

### CROSS-REFERENCE TO RELATED APPLICATION

This application is based upon and claims the benefit of priority from Japanese Patent Applications No. 2012-068080, filed Mar. 23, 2012; the entire contents of which are incorporated herein by reference.

### FIELD

Embodiments described herein relate generally to an adapter for attaching lighting equipment to the ceiling, a luminaire in which the adapter is combined with the lighting equipment, and a method of attaching the lighting equipment using the adapter.

### BACKGROUND

For example, when lighting equipment of a ceiling mounting type is replaced with an LED base light, after the existing lighting equipment is removed, a relatively large opening emerges in the ceiling. If the base light to be attached anew is smaller than the opening, the base light may be unable to be attached to the ceiling surface in that state. Therefore, in such a case, a relatively large tabular adapter that closes the opening is necessary.

If the base light is attached after the opening in the ceiling is closed by the adapter, it takes time to perform wiring and the like. Therefore, usually, after the base light is provisionally fastened to the adapter, the base light and the adapter are attached to the ceiling together.

However, if the base light is provisionally fastened to the adapter, it is necessary to align the base light with the adapter and fix the base light with screws or the like. This increases man-hours and complicates work.

Therefore, there is a demand for development of an adapter that can easily attach the lighting equipment.

### BRIEF DESCRIPTION OF THE DRAWINGS

FIG. 1 is an external perspective view of a luminaire in a state in which a base light is attached to the ceiling using an adapter according to an embodiment;

FIG. 2 is a plan view of the base light shown in FIG. 1 viewed from a light extraction side;

FIG. 3 is a disassembled perspective view of the base light shown in FIG. 1;

FIG. 4 is a sectional view of the base light taken along line Y-Y in FIG. 2;

FIG. 5 is a partially enlarged sectional view of a portion A shown in FIG. 4;

FIG. 6 is a perspective view of the base light shown in FIG. 1 viewed from the ceiling side;

FIG. 7 is a perspective view of the adapter shown in FIG. 1 viewed from a base light attachment side;

FIG. 8 is a perspective view of the adapter shown in FIG. 7 viewed from the ceiling side;

FIG. 9 is a sectional view of the adapter taken along F9-F9 in FIG. 7; and

FIG. 10 is a partially enlarged sectional view of the adapter taken along F10-F10 in FIG. 8.

### DETAILED DESCRIPTION

In general, according to one embodiment, an adapter includes: a tabular body configured to close the existing attachment hole opened in the ceiling in a state in which the existing lighting equipment is removed; and a positioning convex section protrudingly provided on the front surface of the tabular body on a side remote from the ceiling. A part of a chassis of lighting equipment to be attached anew is partially projected toward the rear surface of a substrate mounted with a light-emitting element and forms a contact convex section. As a result, a fitting concave section is formed on the rear side of the contact convex section. The positioning convex section of the adapter is fit in the fitting concave section formed on the rear surface of the chassis, whereby the lighting equipment to be attached anew is positioned with respect to and combined with the adapter and collectively attached to the ceiling together with the adapter.

If lighting equipment is attached to the ceiling using the adapter according to the embodiment, first, the existing lighting equipment is removed from the ceiling. An adapter including a tabular body configured to close the existing attachment hole opened in the ceiling and a reinforcing rib provided on the front surface of the tabular body is prepared. Lighting equipment to be attached anew including a contact convex section formed by projecting a chassis in a rail shape toward the rear surface of an elongated substrate mounted with a light-emitting element to bring a part of the chassis into contact with the rear surface is prepared. The reinforcing rib of the adapter is fit in a fitting concave section formed on the rear side of the contact convex section of the chassis of the lighting equipment to be attached anew. The lighting equipment is combined with the adapter in a state in which the lighting equipment is positioned with respect to the adapter. The adapter and the lighting equipment in this combined state are collectively attached to the ceiling.

Various embodiments will be described hereinafter with reference to the accompanying drawings.

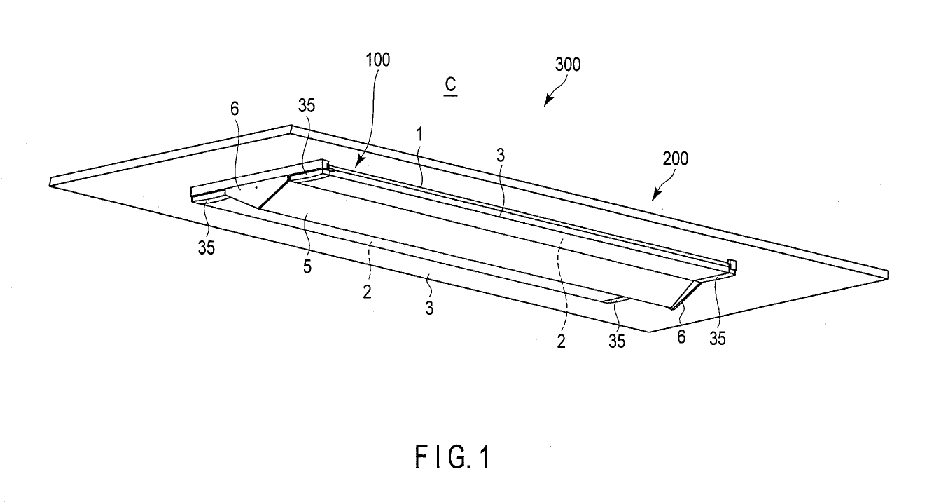

FIG. 1 is an external perspective view of a state in which a luminaire 300 according to an embodiment is attached to a ceiling C. In the luminaire 300, a base light 100 (lighting equipment) is positioned with respect to and combined with an adapter 200 explained below. With the luminaire 300, it is possible to collectively attach the base light 100 and the adapter 200 to the ceiling C together without provisionally fastening the base light 100 to the adapter 200.

The adapter 200 closes an opening emerging in the ceiling C after the existing lighting equipment (not shown in the figure) is removed from the ceiling C, i.e., an attachment hole (not shown in the figure) for the existing lighting equipment and enables attachment of the base light 100 to the ceiling C. In other words, if the attachment hole after the removal of the existing lighting equipment is larger than the base light 100 to be attached anew, the base light 100 may be unable to be attached in that state. Therefore, the adapter 200 has size that can cover the entire attachment hole. The adapter 200 has, on the front surface side thereof, a structure for positioning the base light 100.

First, the base light 100 attached to the ceiling C using the adapter 200 according to this embodiment is explained with reference to FIGS. 1 to 6.

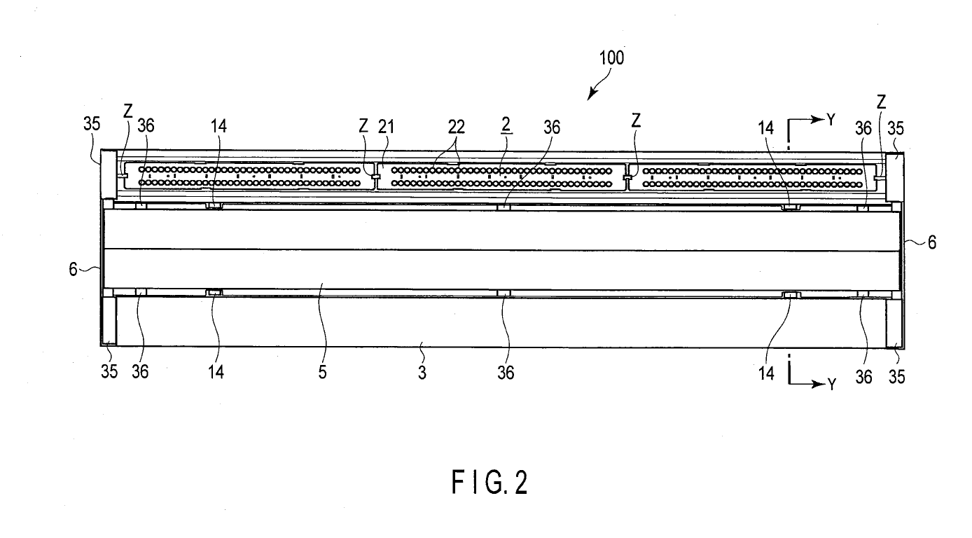

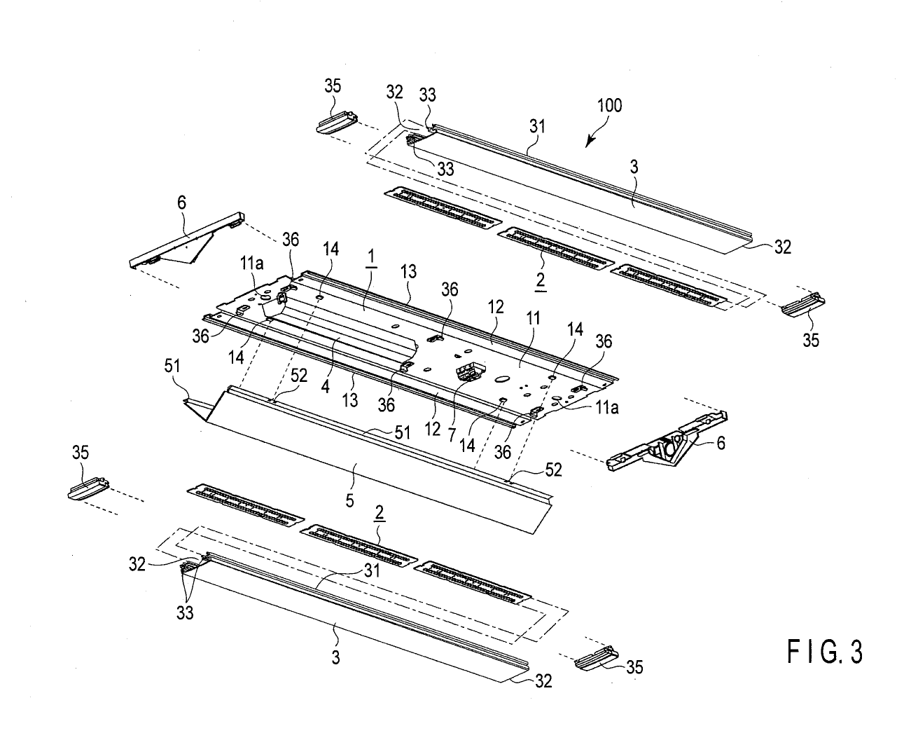

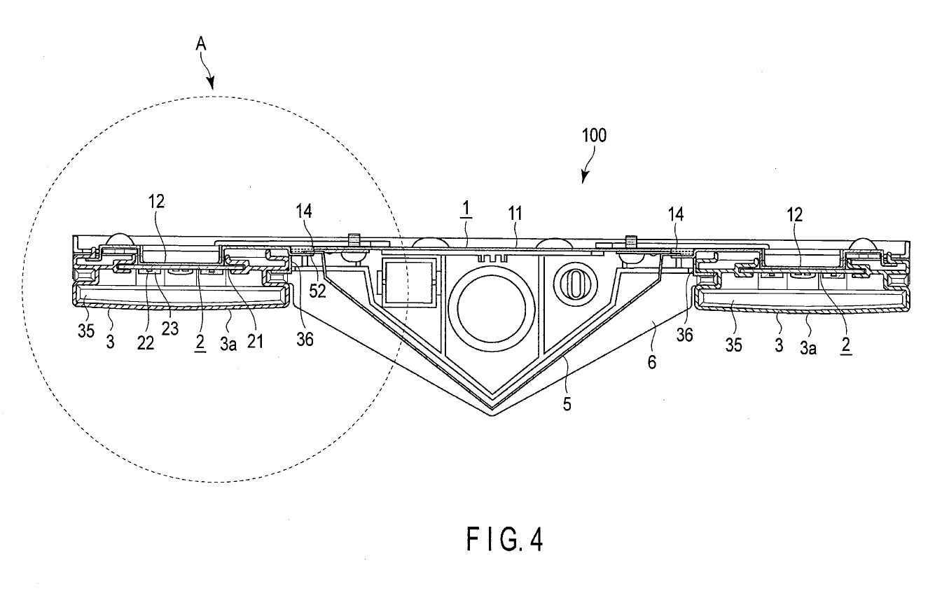

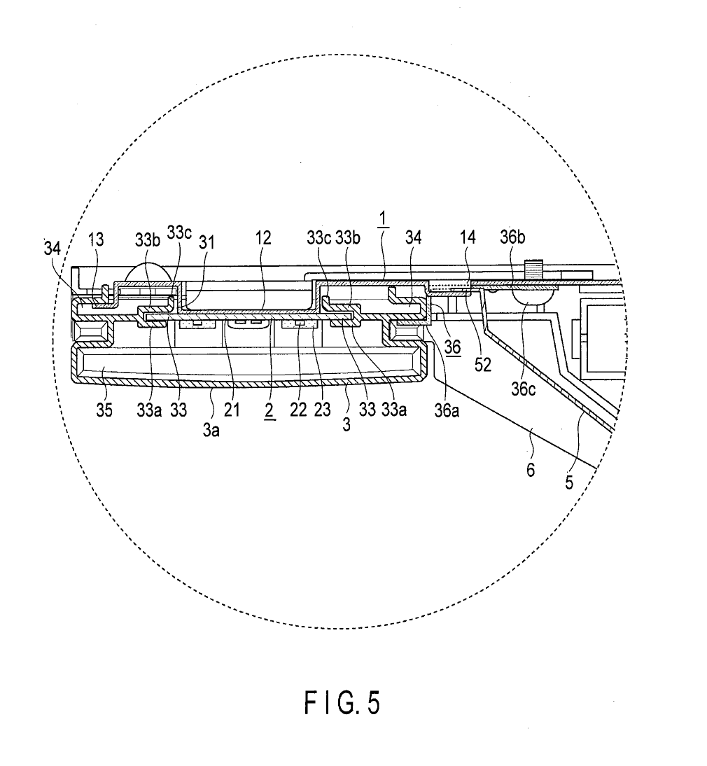

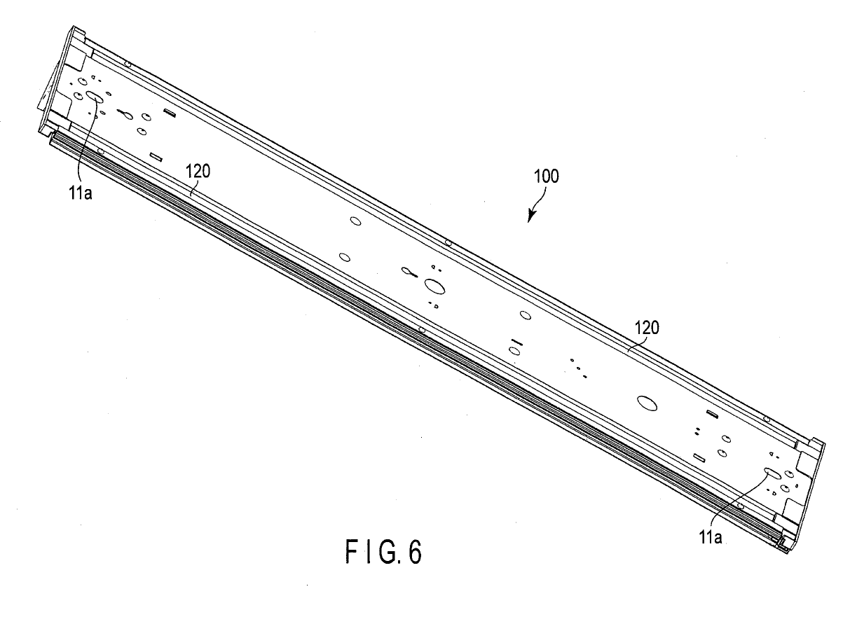

FIG. 2 is a plan view of the base light 100 viewed from a light extraction side. FIG. 3 is a disassembled perspective view of the base light 100. FIG. 4 is a sectional view of the base light 100 taken along line Y-Y in FIG. 2. FIG. 5 is a partially enlarged sectional view of a portion A shown in FIG. 4. FIG. 6 is a perspective view of the rear surface of the base light 100 viewed from the ceiling side. The base light 100 is formed in an elongated flat substantially rectangular shape. In the following explanation, the light extraction side is referred to as front surface side and a side facing the ceiling C is referred to as rear surface side.

The base light 100 includes an elongated substantially rectangular tabular chassis 1, plural elongated belt-like light source sections 2 attached to the front surface side of the chassis 1, elongated tube-like cover members 3 having a milky-white color and translucency that cover the plural light source sections 2, a lighting device 4 that subjects the light source sections 2 to lighting control, a center cover 5 having a substantially V shape in cross section attached to the center of the chassis 1, and two side plates 6. The front surface side of such a base light 100 is a light irradiating surface and the rear surface side is an attachment surface to the ceiling C.

The chassis 1 is formed by profiling a metal plate having thermal conductivity such as galvanized sheet steel. The chassis 1 plays a function of attaching plural members forming the base light 100, a function of a thermal radiation member for allowing heat generated in the light source sections 2 to escape, and a function of a strength member that gives mechanical strength to the base light 100.

The chassis 1 includes a flat top plate surface 11 in the center and includes, at both end edges along a longitudinal direction of the chassis 1, two elongated disposing sections 12, 12 for attaching the plural light source sections 2 with the rear surfaces thereof in contact with one another. Each of the disposing sections 12 is integrally formed by bending the chassis 1 on lines each along the longitudinal direction to project a part of the chassis 1 to the front surface side. The disposing section 12 has, at the projected top of the chassis 1, an elongated flat surface with which the rear surfaces of the light source sections 2 are brought into contact and thermally combined. In other words, the disposing section 12 functions as a contact convex section having a top surface with which the rear surfaces of substrates 21 explained below of the light source sections 2 are brought into contact. The disposing section 12 in this embodiment has length exceeding combined length of three light source sections 2. In other words, the two disposing sections 12 are provided over the entire length of the chassis 1 and also play a function of reinforcing ribs that increase mechanical strength along the longitudinal direction of the chassis 1.

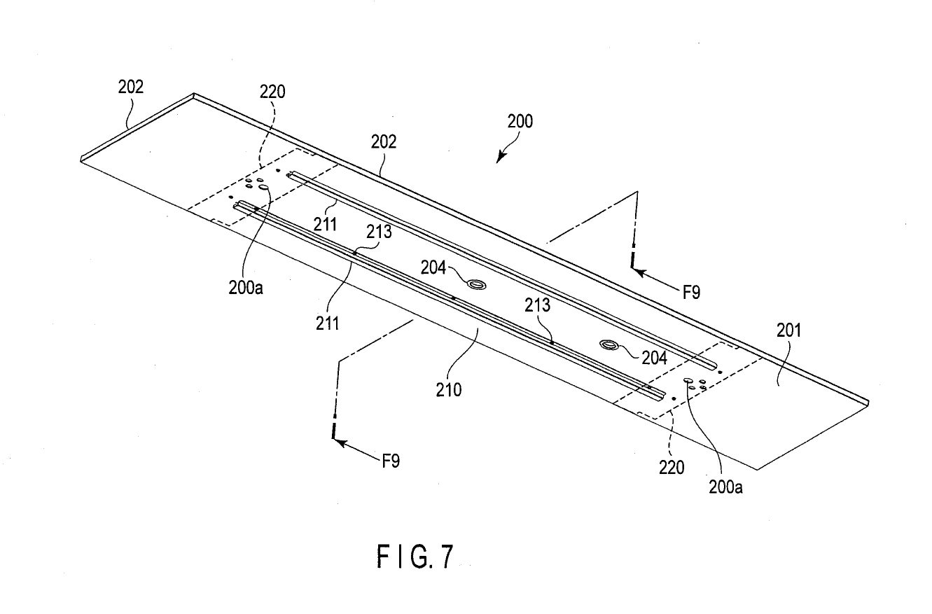

On the other hand, as a result of profiling the chassis 1 and forming the two disposing sections 12, two fitting grooves 120 are formed on the rear surface side of the chassis 1. As shown in FIG. 6, the two fitting grooves 120 are exposed on the rear surface of the base light 100 and function as fitting concave sections in which two reinforcing ribs 210 (positioning convex sections) (see FIG. 7) of the adapter 200 explained below are fit.

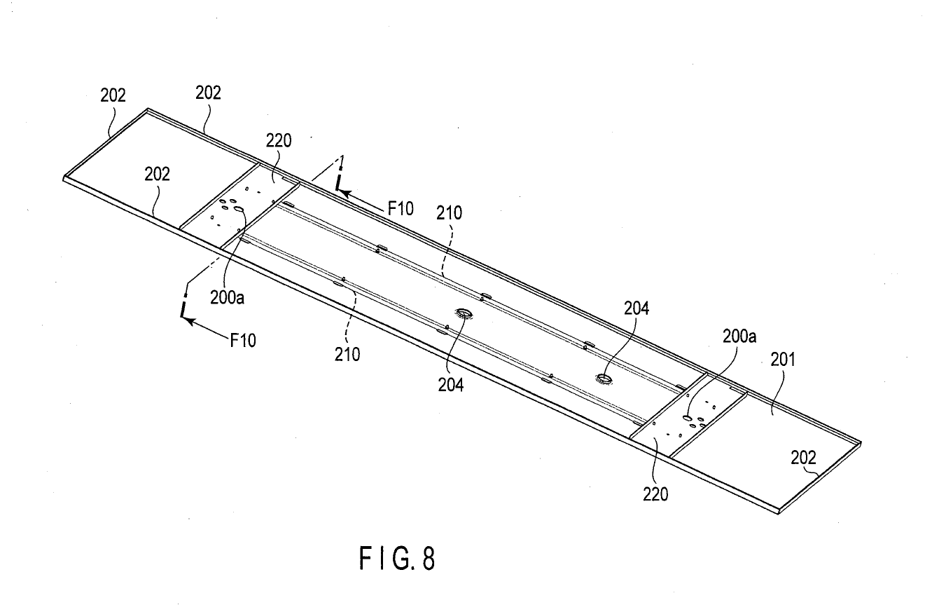

Attachment holes 11a are respectively formed near both ends in the longitudinal direction of the top plate surface 11 of the chassis 1. A pair of attachment bolts (not shown in the figure) provided in the structure of the ceiling C are pierced through the attachment holes 11a from the rear surface side and fastened by not-shown nuts arranged on the front surface side of the chassis 1 to fix the chassis 1 to the ceiling C. At this point, the adapter 200 shown in FIG. 1 is held between the ceiling C and the chassis 1. Therefore, in the adapter 200, attachment holes 200a (see FIGS. 7 and 8) are provided in positions where the attachment holes 200a overlap the attachment holes 11a of the chassis 1.

The light source section 2 includes an elongated rectangular belt-like substrate 21, plural light-emitting elements 22 mounted on the surface of the substrate 21, and phosphor layers 23 that cover the light-emitting elements 22. In FIG. 2, in order to clearly show the structure of the light source section 2, one cover member 3 (on the upper side in the figure) is shown in transparence.

The substrate 21 is formed of an insulating material, for example, a material such as glass epoxy resin (FR-4) in an elongated rectangular shape. A wiring pattern layer formed of a copper foil is formed on the front surface side of the substrate 21. A resist layer is formed on the wiring pattern layer as appropriate. As a material of the substrate 21, a ceramics material, a synthetic resin material, or a base substrate of metal formed by superimposing an insulating layer over the entire surface of a base plate having satisfactory thermal conductivity and excellent heat dissipation of aluminum or the like to improve heat dissipation of the light-emitting elements 22 can be used. The material is not specifically limited.

On the surface layer of the substrate 21, a white resist layer having high reflectance is superimposed over substantially the entire surface excluding a mounting region for the light-emitting elements 22 and a mounting portion for components. Consequently, light traveling in the lateral direction in light radiated by the light-emitting elements 22 is reflected on the surface of the white resist layer having high reflectance and radiated to the front surface side.

The plural light-emitting elements 22 include LED bear chips. As LED bear chips, for example, LED bear chips that emit blue light are used in order to cause the light source section 2 to emit white light. The LED bear chips are bonded on the wiring pattern layer using a silicon resin insulative adhesive and electrically connected to the wiring pattern layer by a bonding wire.

The phosphor layers 23 are formed of translucent synthetic resin, for example, transparent silicone resin and contain an appropriate amount of phosphors such as YAG:Ce. The phosphor layers 23 are formed in a substantially cylindrical shape having a small height dimension to cover the respective light-emitting elements 22 one by one. The phosphors are excited by light emitted by the light-emitting elements 22 and radiate light having a color different from a color of the light emitted by the light emitting elements 22. In this reference example, since the light-emitting elements 22 emit the blue light, yellow phosphors that radiate yellowish light in a complementary color relation with the blue light are used as the phosphors for allowing the light source sections 2 to emit white light.

The shape of the phosphor layers 23 is not specifically limited as long as the phosphor layers 23 can cover the respective light-emitting elements 22. A mountain shape and a linear shape that continuously covers the plural light-emitting elements 22 can be applied. As the light-emitting elements 22, LED packages of a surface mounting type may be used. A mounting system and a mounting form are not specifically limited.

The light source sections 2 having the structure explained above are coupled in the longitudinal direction thereof and mounted on the cover member 3. In this embodiment, the three light source sections 2 are coupled and mounted on the inside of one cover member 3. Six light source sections 2 in total are incorporated in the base light 100. When a longer base light is configured, the number of light source sections 2 coupled in the longitudinal direction is increased.

Adjacent ends of the light source sections 2 are connected via wires Z shown in FIG. 2. The wires Z are led out from at least one end of the light source sections 2 at both the ends among the coupled light source sections 2. The wires Z led out from the end are connected to the lighting device 4 attached to the chassis 1 to enable power feed to the light source sections 2.

The cover member 3 includes a front surface section 3a that covers the front surface side of the light source sections 2 and a slit-like open section 31 that exposes the rear surfaces of the light source sections 2. Therefore, when the cover member 3 is attached to the chassis 1, the rear surfaces of the substrates 21 of the light source sections 2, through the open section 31, come into contact with the flat surface of the disposing section 12 in the chassis 1 and the substrates 21 are thermally combined with the chassis 1.

The cover member 3 is formed of an insulative material having translucency such as acrylic resin or polycarbonate resin. In this embodiment, the cover member 3 is formed by extrusion molding of polycarbonate. The cover member 3 is formed in a long tube shape. The sectional shape of the cover member 3 is symmetrical. The cover member 3 is attached to the disposing sections 12 formed on both the sides of the chassis 1. The cover member 3 has length substantially the same as the length of the disposing sections 12. Openings 32 for inserting through the light source sections 2 are provided at both ends in the longitudinal direction of the cover member 3.

For example, as shown in FIG. 5, a pair of holding grooves 33 opposed to each other and opened are formed over the entire length at edge portions along the longitudinal direction of the open section 31. The pair of holding grooves 33 are formed between a front surface side supporting section 33a and a rear surface side supporting section 33b along the longitudinal direction. On the outer side of the holding grooves 33, a pair of locking sections 34 formed in a substantially C shape in cross section and opened to the inner side are formed over the entire length in the longitudinal direction.

Both end edges along the longitudinal direction of the substrates 21 of the plural light source sections 2 are inserted through the pair of holding grooves 33 opposed to each other of the cover member 3. Specifically, as shown in FIG. 3, the three light source sections 2 are connected by the wires Z and inserted from one opening 32 of the cover member 3. Both the end edges along the longitudinal direction of the substrates 21 of the light source section 2 are guided and held by the pair of holding grooves 33. Consequently, the light source sections 2 are held by the cover member 3 and integrated with the cover member 3.

Lid bodies 35 that close the openings 32 at both the ends in the longitudinal direction of the cover member 3 are attached to the openings 32. In other words, as explained above, after the three light source sections 2 are inserted into the pair of holding grooves 33 of the cover member 3, the lid bodies 35 are attached to close both the ends of the cover member 3. By attaching the lid bodies 35 to the openings 32, both the ends of the cover member 3 in this way, it is possible to prevent a deficiency of coming-off of the light source sections 2 from the cover member 3.

The lid bodies 35 are formed of a translucent material having insulating properties and having light diffusing properties from the surface to the inside of the material. Like the cover member 3, the lid bodies 35 have milky-white color. Therefore, it is possible to irradiate light, which is emitted from the light source sections 2, to the outside via the lid bodies 35.

The lid bodies 35 are combined with side plates 6 explained below and positions of the lid bodies 35 are regulated. The wires Z that connect the ends of the substrates 21 and the lighting device 4 are present on the rear surface side of the lid bodies 35 and between the lid bodies 35 and the end front surface of the chassis 1. The wires Z led out from the end of substrates 21 have to pass the end of the chassis 1 before the wires Z reach the lighting device 4. However, the lid bodies 35 on the front surfaces of the wires Z shines because the lid bodies 35 transmit light. Therefore, the presence of the wires Z present at the ends of the apparatus main body becomes inconspicuous.

The lighting device 4 is attached to the front surface side of the top plate surface 11 of the chassis 1. The lighting device 4 subjects the light source sections 2 to lighting control. The lighting device 4 is configured by housing a circuit board mounted with plural circuit components in a box-like case. The lighting device 4 is connected to a not-shown commercial alternating-current power supply and converts an alternating current into a direct current and outputs the direct current. The lighting device 4 is configured by, for example, connecting a smoothing capacitor between output terminals of a full-wave rectifier circuit and connecting a direct-current voltage converting circuit and current detecting means to the smoothing capacitor. The lighting device 4 is connected to the light-emitting elements 22 via the substrates 21, supplies a direct-current output of the lighting device 4 to the light-emitting elements 22, and subjects the light-emitting elements 22 to lighting control.

A terminal table 7 is attached to the front surface side of the top plate surface 11. Wires not shown in the figure such as a power supply line, a feed line, and a dimming signal line are connected to the terminal table 7. The lighting device 4 dimes the light source sections 2 on the basis of a dimming signal.

The center cover 5 is disposed on the front surface side of the top plate surface 11 of the chassis 1. The center cover 5 is formed of a plate material of metal such as galvanized sheet steel. The side surface shape of the center cover 5 is formed in a V shape. White painting is applied to at least the front surface side of the center cover 5. The center cover 5 functions as a reflecting plate.

Plural attachment tongue pieces 52 are formed at an end edge 51 (see FIG. 3) along the longitudinal direction where the center cover 5 expands and opens. On the other hand, on the chassis 1 side opposed to the attachment tongue pieces 52, insertion holes 14 formed by slightly bulging and deforming the chassis 1 to the front surface side by cutting are formed.

The expanding and opening end edge of the center cover 5 can be elastically deformed in the width direction around the top of the V shape as a center to reduce a width dimension of the expansion and opening. Therefore, when the center cover 5 is attached to the chassis 1, the center cover 5 is elastically deformed to reduce the width dimension of the expansion and opening, the attachment tongue pieces 52 are aligned with the positions of the insertion holes 14, and the elastic deformation is released to return the center cover 5 to the original state. Consequently, the attachment tongue pieces 52 are inserted into the insertion holes 14 and the center cover 5 is attached to the chassis 1.

When the center cover 5 is attached to the chassis 1 in this way, the end edge 51 of the center cover 5 is brought into contact with fixed piece sections 36b of stopper members 36. Therefore, for example, even if attachment screws 36c of the stopper members 36 are loosened by vibration over time, coming-off and excessive movement of the stopper members 36 can be suppressed. Consequently, sure thermal combination of the chassis 1 and the substrate 21 can be expected.

In addition, the lighting device 4, the terminal table 7, the wires, and the like are covered with the center cover 5 and cannot be visually recognized from the outside. Therefore, the external appearance of the luminaire 300 is not spoiled. The side plates 6 are formed of a synthetic resin material and attached to close both the ends in the longitudinal direction of the chassis 1.

The adapter 200 according to this embodiment is explained with reference to FIGS. 7 to 10.

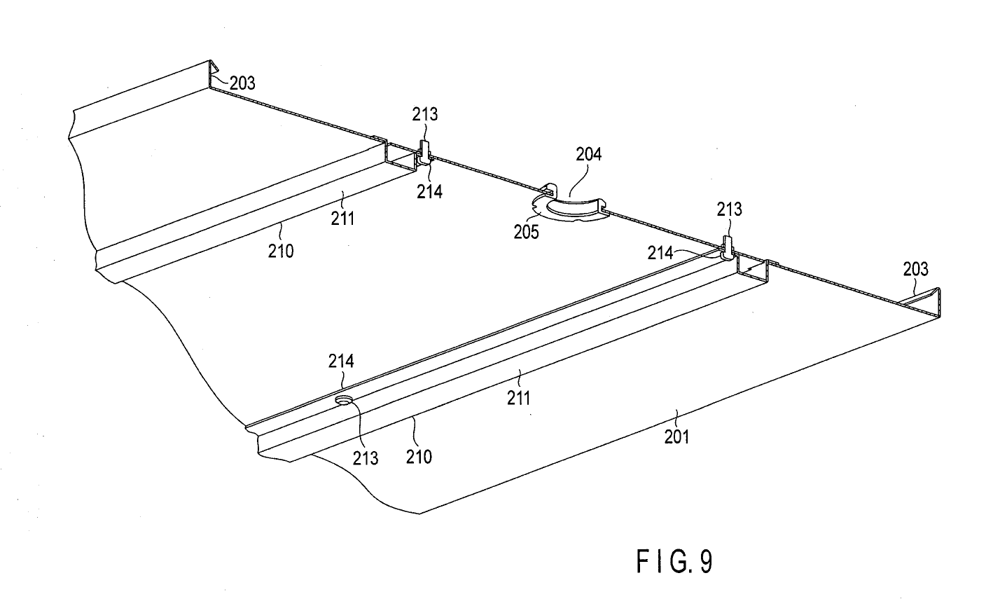

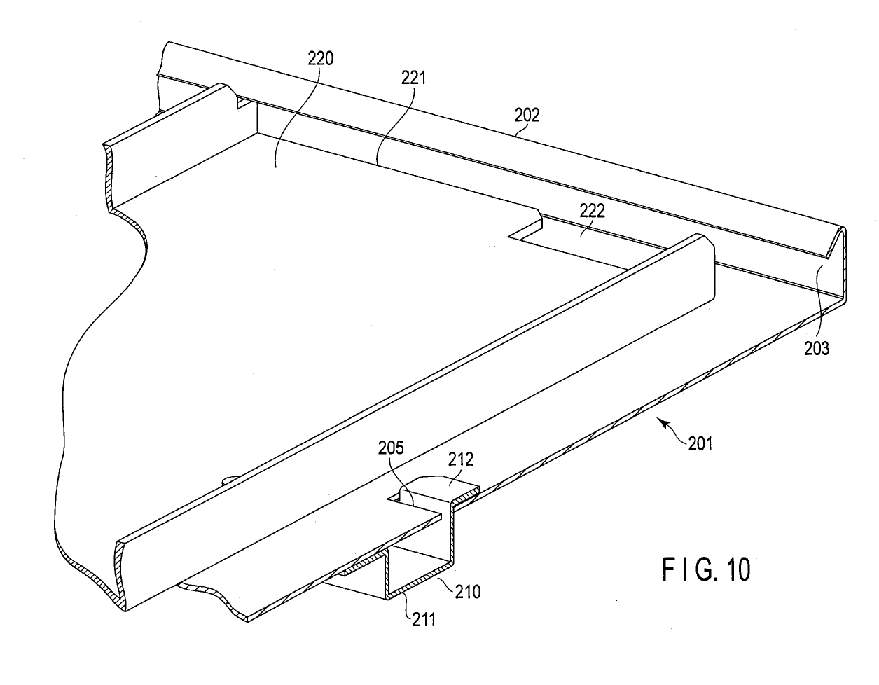

FIG. 7 is a perspective view of the adapter 200 viewed from the front surface side, i.e., the base light 100 side. FIG. 8 is a perspective view of the adapter 200 viewed from the rear surface side, i.e., the ceiling C side. FIG. 9 is a sectional view of the adapter 200 taken along F9-F9 in FIG. 7. FIG. 10 is a partially enlarged sectional view of the adapter 200 taken along F10-F10 in FIG. 8.

The adapter 200 includes a substantially rectangular tabular plate 201 (a tabular body) larger than the base light 100. The plate 201 is formed by profiling one metal plate and bending all edges of the metal plate. Specifically, for example, as indicated by a cross section shown in FIG. 10, edges 202 on the four sides of the plate 201 are folded back to the rear surface side thereof on the outer side of not-shown attachment hole exposed in the ceiling C (hole exposed in the ceiling after the existing lighting equipment is removed).

More specifically, the edges 202 folded back to the rear surface side of the plate 201 are bent once again in a direction toward the rear surface of the plate 201 and form engagement edge sections 203 (FIGS. 9 and 10) with which ends of a reinforcing plate 220 explained below can be engaged. By providing the engagement edge sections 203 curled substantially in a tubular shape are provided on the four sides of the plate 201, it is possible to increase mechanical strength in the peripheral sides of the plate 201.

Plural through-holes are provided in the plate 201. The holes of the plate 201 are the attachment holes 200a through which attachment bolts (not shown) projecting from the ceiling C side are inserted when the base light 100 is attached with the plate 201 held between the base light 100 and the ceiling C. Alternatively, the holes of the plate 201 are wiring holes 204 (FIGS. 7 and 8) for inserting through wires that connect the lighting device 4 to a not-shown commercial alternating-current power supply. As shown in FIG. 9, bushes 205 for protecting the wires are attached to the wiring holes 204.

Two reinforcing ribs 210, 210 are provided on the front surface side of the plate 201. Each of the reinforcing ribs 210 is extended along the longitudinal direction (a first direction) of the plate 201. The two reinforcing ribs 210 have the same shape and are attached in directions opposite to each other to be symmetrical with respect to the center line along the longitudinal direction of the plate 201. The length of each of the reinforcing ribs 210 is set slightly smaller than the length of the two fitting grooves 120 of the chassis 1 provided on the rear surface of the base light 100. In this embodiment, the length of the reinforcing rib 210 is set about 0.02 mm to 3 mm smaller than the length of the fitting grooves 120.

The reinforcing rib 210 is formed by profiling and bending one elongated metal plate. Specifically, the reinforcing rib 210 is bent plural times in plural linear places along the longitudinal direction thereof such that the cross section thereof is generally formed in a hat shape. In other words, the reinforcing rib 210 has a flat top surface 211 projecting most in a state in which the reinforcing rib 210 is attached to the plate 201. The top surface 211 is opposed to the bottom surface of the fitting groove 120 of the chassis 1 in a state in which the base light 100 is combined with the adapter 200. In order to increase the thermal conductivity of the reinforcing rib 210 to the chassis 1, a projecting surface on the outer side of the reinforcing rib 210 is not painted.

At one edge along the longitudinal direction of the reinforcing rib 210, for example, as shown in FIG. 10, plural tongue pieces 212 respectively inserted into plural slits 205 provided in the plate 201 are integrally extended. As shown in FIG. 8, the plural tongue pieces 212 are provided spaced apart from one another along the longitudinal direction. The tongue pieces 212 are bent to the outer side after passing through the slits 205 of the plate 201. One edge of the reinforcing rib 210 is engaged with the plate 201.

On the other hand, as shown in FIG. 9, at the other edge along the longitudinal direction of the reinforcing rib 210, plural screw holes 214 through which plural screws 213 for fixing the other edge to the plate 201 are inserted are provided. The screw holes 214 are respectively provided in positions opposed to the tongue pieces 212 on the opposite side. Specifically, the reinforcing rib 210 is fixed to the plate 201 by inserting the plural tongue pieces 212 through the slits 205 of the plate 201, rotating the reinforcing rib 210 about the longitudinal axis thereof, inserting the screws 213 through the screw holes 214 provided at the other edge, and fastening the reinforcing rib 210 to the plate 201.

The reinforcing rib 210 fixed to the plate 201 in this way has a tubular structure. Therefore, the reinforcing rib 210 functions as a strength member that can give mechanical strength along the longitudinal direction of the plate 201. The reinforcing rib 210 functions as a positioning member in assembling the base light 100 to the adapter 200. The reinforcing rib 210 fits in the fitting groove 120 of the chassis 1 and functions to position the base light 100 with respect to the adapter 200.

As shown in FIGS. 8 and 10, two reinforcing plates 220 (reinforcing members) are provided on the rear surface side of the plate 201. The reinforcing plate 220 in this embodiment is formed in a substantially U shape in cross section formed by bending respective edges along the longitudinal direction thereof to the rear surface side. Mechanical strength is given to the reinforcing plate 220. However, the reinforcing plate 220 may be formed in other shapes such as an L shape in cross section and does not have to be formed in a plate shape.

In any case, the two reinforcing plates 220 are attached to positions where at least a part of the reinforcing plates 220 are respectively opposed to the reinforcing ribs 210 on the plate front side across the plate 201. More specifically, each of the reinforcing plates 220 is extended in the width direction (a second direction) crossing the longitudinal direction of the plate 201 and arranged in a position where the reinforcing plate 220 overlaps both ends of the two reinforcing ribs 210. In this way, the reinforcing rib 210 and the reinforcing plate 220 are arranged in the positions where the reinforcing rib 210 and the reinforcing plate 220 partially overlap each other across the plate 201. Consequently, higher mechanical strength can be given to the plate 201. The two reinforcing plates 220 are not fixed to the plate 201 using screws or the like and are attached to the plate 201 using the engagement edge sections 203 of the plate 201.

Both the ends in the longitudinal direction of each of the reinforcing plates 220 are engaged with the engagement edge sections 203 of the plate 201. As shown in FIG. 10, a cutout 222 not reaching the engagement edge section 203 is provided on an end side 221 where the reinforcing plate 220 engages with the engagement edge section 203. The cutout 222 is also provided at the not-shown other end of the reinforcing plate 220. The cutouts 222 at both the ends are provided on opposite sides not opposed to each other across the center line rather than in positions line-symmetrical with respect to the center axis of the plate 201. A dimension along the longitudinal direction of the reinforcing plate 220 is designed substantially the same as the width direction length of the plate 201. Both the end sides of the reinforcing plate 220 are in contact with the inner side surface of the engagement edge section 203 in a state in which the reinforcing plate 220 is attached to the plate rear surface.

Specifically, when the reinforcing plate 220 is attached to the plate 201, the reinforcing plate 220 is brought into contact with the rear surface of the plate 201 in a state in which the longitudinal axis of the reinforcing plate 220 is slightly inclined with respect to the width direction of the plate 201. The reinforcing plate 220 is rotated to a posture in which the longitudinal axis of the reinforcing plate 220 coincides with the width direction of the plate 201. This state is shown in FIGS. 8 and 10.

In this embodiment, the reinforcing plate 220 is opposed to the rear surface of the plate 201 in a posture in which the reinforcing plate 220 is slightly rotated in the counterclockwise direction in FIG. 8. The reinforcing plate 220 is brought close to the rear surface of the plate 201 such that both the end sides of the reinforcing plate 220 avoid the engagement edge section 203. After the reinforcing plate 220 comes into contact with the plate rear surface, the reinforcing plate 220 is rotated in the clockwise direction in FIG. 8 and returned to the posture along the width direction. At this point, the cutouts 222 provided on both the end sides of the reinforcing plate 220 function to prevent interference of the end sides of the reinforcing plate 220 and the engagement edge sections 203.

When the reinforcing plate 220 is attached to the plate 201 as explained above, both the ends of the reinforcing plate 220 enter under the engagement edge sections 203 of the plate 201 and both the ends of the reinforcing plate 220 respectively engage with the engagement edge sections 203. Consequently, when the adapter 200 is attached to the ceiling C, a deficiency of coming-off of the reinforcing plate 220 can be prevented.

Specifically, if both the ends of the reinforcing plate 220 are not engaged with the edge sections along the longitudinal direction of the plate 201, it is likely that, when the adapter 200 is attached to the ceiling C, the reinforcing plate 220 falls into a not-shown attachment hole of the ceiling C and, when the adapter 200 is fastened, the reinforcing plate 220 comes off the plate 201. On the other hand, by engaging both the ends of the reinforcing plate 220 with the engagement edge section 203 of the plate 201 as in this embodiment, it is possible to prevent a deficiency of coming-off of the reinforcing plate 220 due to fastening and fixing of the adapter 200 and prevent deformation of the plate 201 due to the coming-off.

An operation for attaching the base light 100 to the ceiling C using the adapter 200 having the structure explained above is explained below.

First, the not-shown existing lighting equipment is removed from the ceiling C. After the existing lighting equipment is removed, the not-shown attachment hole emerges in the ceiling C.

Subsequently, the base light 100 to be attached anew is positioned on the front surface side of the adapter 200 to overlap the adapter 200. When the base light 100 is positioned, the two reinforcing ribs 210, 210 provided on the front surface side of the adapter 200 are fit in the two fitting grooves 120 present on the rear surface of the chassis 1 of the base light 100 to position the base light 100 with respect to the adapter 200.

When the base light 100 is positioned, the top surface 211 of the reinforcing rib 210 of the adapter 200 may come into contact with the bottom surface of the fitting groove 120 of the chassis 1. A side surface of the reinforcing rib 210 of the adapter 200 may come into contact with a side surface of the fitting groove 120 of the chassis 1. In other words, at least a part of the reinforcing rib 210 of the adapter 200 may come into contact with at least a part of the fitting groove 120 of the chassis 1.

In this embodiment, the height of the reinforcing rib 210 is designed to prevent at least the top surface 211 of the reinforcing rib 210 from coming into contact with the bottom surface of the fitting groove 120 of the chassis 1 such that the rear surface of the chassis 1 is satisfactorily in contact with the front surface of the adapter 200 in a relatively large area in a state in which the adapter 200 and the base light 100 are combined as explained above.

Thereafter, the adapter 200 and the base light 100 positioned and laid one on top of the other are collectively attached to the ceiling C. In attaching the adapter 200 and the base light 100, an operator can handle the adapter 200 and the base light 100 without worrying about a positional shift of the adapter 200 and the base light 100 by fitting the reinforcing rib 210 and the fitting groove 120. Therefore, it is possible to easily insert the not-shown attachment bolts, which project from the structure of the ceiling C, through the attachment holes 200a of the adapter 200 and the attachment holes 11a of the chassis 1 and facilitate attachment work for the luminaire 300.

When the luminaire 300 is attached to the ceiling C as explained above, by tightening the attachment bolts with the not-shown nuts, the chassis 1 is pressed against the adapter 200 and the reinforcing rib 210 is caused to at least partially adhere to the fitting groove 120. In this case, the top surface 211 of the reinforcing rib 210 may adhere to the bottom surface of the fitting groove 120 or the side surface of the reinforcing rib 210 may adhere to the side surface of the fitting groove 120.

In any case, the reinforcing rib 210 present on the front surface side of the adapter 200 adheres to the fitting groove 120 present on the rear surface of the chassis 1 of the base light 100. Consequently, heat transmitted from the substrate 21 of the base light 100 to the disposing section 12 is satisfactorily transmitted to the reinforcing rib 210 via the fitting groove 120 on the rear side of the chassis 1. It is possible to satisfactorily radiate the heat of the light source sections 2.

With the adapter 200 according to the embodiment explained above, since the reinforcing rib 210 having the positioning function for the base light 100 is provided on the attachment side (i.e., the front surface side) of the base light 100, it is possible to easily position the base light 100 with respect to the adapter 200 and easily attach the base light 100 to the ceiling C instead of the existing lighting equipment.

In this case, since a member for provisionally fastening the base light 100 to the adapter 200 is unnecessary, it is possible to reduce the number of components, reduce assembly man-hour, and reduce expenses required for the attachment of the base light 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the methods described herein may be made without departing from the spirit of the inventions. The accompanying claims and their equivalents are intended to cover such forms or modifications as would fall within the scope and spirit of the inventions.

What is claimed is:

1. An adapter comprising:
a tabular body configured to close an attachment hole opened in a ceiling after a lighting equipment of a first type has been removed; and
a positioning convex section protrudingly provided on a front surface of the tabular body that faces away from the ceiling and configured to fit in a concave section formed on a rear side of a contact convex section of a lighting equipment of a second type to position the lighting equipment of the second type with respect to the tabular body, the contact convex section being formed by partially projecting a chassis of the lighting equipment of the second type toward a rear surface of a substrate mounted with a light-emitting element such that a part of the chassis is brought into contact with the rear surface of the substrate.

2. The adapter of claim 1, wherein the positioning convex section is a reinforcing rib for the tabular body that extends in a first direction along the front surface of the tabular body.

3. The adapter of claim 1, wherein the positioning convex section at least partially comes into contact with the concave section.

4. The adapter of claim 1, wherein the lighting equipment of the second type is to be attached to the ceiling via the adapter, such that the positioning convex section at least partially adheres to the concave section.

5. The adapter of claim 4, wherein the positioning convex section has a front surface that faces away from the ceiling, and the lighting equipment of the second type is to be attached to the ceiling via the adapter, such that the front surface adheres to a rear surface of the concave section that faces towards the ceiling.

6. The adapter of claim 4, wherein the positioning convex section has a side surface, and the lighting equipment of the second type is to be attached to the ceiling via the adapter, such that the side surface adheres to a side surface of the concave section.

7. The adapter of claim 1, wherein the positioning convex section is not painted on a surface that opposes the concave section.

8. The adapter of claim 2, further comprising a reinforcing member extended in a second direction, which crosses the first direction, along a rear surface of the tabular body.

9. The adapter of claim 8, wherein the reinforcing rib and the reinforcing member are arranged to partially overlap each other across the tabular body.

10. The adapter of claim 8, wherein an edge of the tabular body is folded back toward the rear surface side of the tabular body, and an end of the reinforcing member engages with an inner side of the folded-back edge of the tabular body.

11. A luminaire comprising:
an adapter including a tabular body configured to close an attachment hole opened in a ceiling after a lighting equipment of a first type has been removed, and a positioning convex section protrudingly provided on a front surface of the tabular body that faces away from the ceiling; and
a lighting equipment of a second type having a convex section and a concave section formed on a rear side of the convex section, the convex section being formed by partially projecting a chassis of the lighting equipment of the second type toward a rear surface of a substrate mounted with a light-emitting element such that a part of the chassis is brought into contact with the rear surface of the substrate,
the positioning convex section of the adapter being configured to fit in the concave section of the lighting equipment of the second type to position the lighting equipment of the second type with respect to the tabular body.

12. The luminaire of claim 11, further comprising an attachment member configured to collectively attach the lighting equipment of the second type and the adapter to the ceiling after the lighting equipment of the second type has been positioned with respect to and combined with the adapter.

13. A method of attaching a luminaire comprising:
removing an existing lighting equipment from a ceiling;
preparing an adapter including a tabular body configured to close an attachment hole in the ceiling for the existing lighting equipment and a reinforcing rib provided on a front surface of the tabular body that faces away from the ceiling;
preparing a new lighting equipment to be attached, the new lighting equipment including a convex section formed by partially projecting a chassis of the new lighting equipment toward a rear surface of a substrate mounted with a light-emitting element such that a part of the chassis is brought into contact with the rear surface of the substrate;
fitting the reinforcing rib of the adapter in a concave section formed on a rear side of the convex section of the chassis of the new lighting equipment and combining the new lighting equipment with the adapter after the new lighting equipment has been positioned with respect to the adapter; and
attaching the adapter and the new lighting equipment in the combined state to the ceiling.

14. The method of claim 13, wherein at least a part of the reinforcing rib of the adapter adheres to the concave section as a result of the attaching.

15. A method of attaching a lighting equipment to a ceiling, the lighting equipment having light-emitting elements and a convex section to which a substrate for the light-emitting elements is attached, the method comprising:
positioning the lighting equipment with respect to an adapter that includes a tabular body and a reinforcing rib provided on a front surface of the tabular body that faces away from the ceiling by fitting the reinforcing rib of the adapter in a concave section formed on a rear side of the convex section of the lighting equipment;
combining the lighting equipment with the adapter after the lighting equipment has been positioned with respect to the adapter; and
attaching the adapter and the lighting equipment in the combined state to the ceiling.

16. The method of claim 15, wherein at least a part of the reinforcing rib of the adapter adheres to the concave section of the lighting equipment as a result of the attaching.
